(19) United States
(12) Patent Application Publication
(10) Pub. No.: US 2013/0225156 A1
(43) Pub. Date: Aug. 29, 2013

(54) Systems and Methods for Convergence and Forecasting for Mobile Broadband Networks

(71) Applicant: Cerion Optimization Services, Inc., (US)

(72) Inventors: Wei Yuan, Plano, TX (US); Will A. Egner, Cedar Park, TX (US); Anil Kollipara, Allen, TX (US); Richard Framjee, Plano, TX (US)

(73) Assignee: Cerion Optimization Services, Inc., Frisco, TX (US)

(21) Appl. No.: 13/781,308

(22) Filed: Feb. 28, 2013

Related U.S. Application Data
(60) Provisional application No. 61/604,997, filed on Feb. 29, 2012.

(51) Int. Cl. H04W 16/22

(52) U.S. Cl. CPC H04W 16/22
USPC 455/422.1

(57) ABSTRACT

An embodiment method of forecasting traffic growth for a mobile wireless network in a network planning period includes determining traffic growth of a plurality of service types, and defining a plurality of clusters each containing a respective quantity of cell sites that share similar traffic growth characteristics. The method further includes determining seasonality factors in traffic growth for the plurality of service types in each of the plurality of clusters, and identifying and rejecting outliers in historical traffic measurements. The method also includes utilizing cyclo-stationary weekly traffic behavior to increase a quantity of sample points to accelerate traffic growth estimator convergence.

This application claims the benefit of U.S. Provisional Application No. 61/604,997, filed on Feb. 29, 2012, entitled “Systems and Methods for Fast Converging and Intelligent Forecasting for Mobile Broadband Networks,” which application is hereby incorporated herein by reference.

### CROSS-REFERENCE TO RELATED APPLICATIONS

This application relates to the following co-pending and commonly assigned patent applications: U.S. patent application Ser. No. 10/585,011, filed Jun. 29, 2006, entitled “System and Method for Analyzing Strategic Network Investments in Wireless Networks”; and U.S. patent application Ser. No. 12/443,956, filed Apr. 1, 2009, entitled “System and Method for Re-home Sequencing Optimization,” which applications are hereby incorporated herein by reference.

### TECHNICAL FIELD

The present invention relates generally to systems and methods for wireless communication network management, and, in particular embodiments, to systems and methods for convergence and forecasting for mobile broadband networks.

### BACKGROUND

The wireless telecommunications industry has been experiencing a tremendous growth in the past few years and, as a result, is often characterized by fierce competition between wireless service providers. In an attempt to increase revenues and profits, it is generally important for the service providers to provide better services with lower costs.

A wireless telecommunication network includes of a wireless access network and a wireless core network. The wireless access network allows subscribers access to the network through its Radio Frequency (RF) equipment so that telecommunication services can be delivered to subscribers. Wireless core networks generally provide the network functionalities other than RF to subscribers, including mobility management, voice call management, packet session management, and transport for voice and data traffic.

FIG. 1A illustrates an example Global System for Mobile Communications (GSM)/General Packet Radio Service (GPRS) network 100. Wireless networks of other technologies, including cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), Long Term Evolution (LTE), and Integrated Digital Enhanced Network (iDEN), are similar to the one shown in FIG. 1A.

As shown in FIG. 1A, different types of core network elements, such as BSCs 110, MSCs 112, GMSCs 114, SGSNs 116, and GGSNs 118, work together with RF equipment at Base Transceiver Stations (BTSs) 120 to provide telecommunication services to subscribers. In a typical wireless network, there are a number of BTSs with RF equipment for providing wireless network access to subscribers. A BTS provides RF coverage of a certain geographic area where subscribers' Mobile Stations (MSs) are able to place and receive telephone calls and packet data (e.g., emails, World Wide Web (WWW) pages, streamed media).

When a subscriber places or receives a voice call in the coverage area of a BTS, the wireless network establishes a wireless connection between the subscriber's MS and the BTS. If the subscriber moves around, the subscriber may leave the coverage area of the BTS, and enter the coverage area of another BTS. In this case the wireless network performs handover, where the first BTS hands over the subscriber's voice call to the second BTS. Due to the mobility of mobile subscribers, there are a number of handovers between adjacent BTSs, especially in those high mobility areas.

BTSs are controlled by a type of core network equipment, named Base Station Controller (BSC). BSCs provide mobility management functionality to the network. A BSC has a parent-to-child (one-to-multiple) relationship to the BTSs that it controls. BTSs controlled by a BSC form the serving area of the BSC. BSCs are connected to another type of core network equipment, called a Mobile Switching Center (MSC). MSCs provide voice call processing and switching functionality to subscribers. An MSC has a parent-to-child (one-to-multiple) relationship to the BSCs to which it is connected. The BSCs connected to an MSC form the serving area of the MSC.

BSCs are also connected to another type of core network equipment, called a Serving GPRS Support Node (SGSN). SGSNs process packet data traffic, and provide mobility management and packet data services to subscribers. An SGSN has a parent-to-child (one-to-multiple) relationship to the BSCs to which it is connected. The BSCs connected to an MSC form the serving area of the SGSN.

A Home Location Register (HLR) is a database storing subscriber profiles and locations in terms of MSC serving areas. A Gateway MSC (GMSC) provides gateway functionality between wireless networks and the wired network Public Switching Telephony Network (PSTN). A Gateway GSN (GGSN) provides gateway functionality between wireless networks and fixed data networks (e.g., the Internet). Network elements in a typical wireless network as illustrated in Figure lA are connected through different types of transport facilities, such as T1s, T3s, OC-3, OC-12, and OC-48.

FIG. 1B illustrates an example Long Term Evolution (LTE) network 150. Evolved Node Bs (eNodeBs) 152 provide user equipments (UEs) 154 wireless access to LTE network. eNodeBs, and are responsible for all radio related functions. eNodeBs 152 are connected to mobile management entities (MMEs) 156 for control plane processing or signaling. eNodeBs 152 also are connected to serving gateways (SGWs) 158 for user plane processing or bearer traffic. Multiple MMEs 156 and SGWs 158 can serve a common geographical area, being connected by a mesh network to the set of eNodeBs 152 in that area. SGWs 158 are connected to packet data network gateways (PGWs) 160 that provide Internet protocol (IP) connectivity to various applications and services in packet data network 162.

MME 156 is the control node that processes the signaling between the UE 154 and the core network, which are all the non-access stratum (NAS) protocols. MME 156 handles establishment, maintenance and release of the bearers through the session management layer of the NAS protocol. MME 156 also establishes security between the network and the UE 154 and through the mobility management layer of the NAS protocol.

SGW 158 serves as the local mobility anchor and transfers all the user IP packets when the UE 154 moves between different eNodeBs 152. SGW 158 also maintains information about the bearers when the UE 154 is in idle state. SGW 158 also performs certain administrative functions such as collecting information for charging and legal interception. It also serves as a mobility anchor for interacting with other 3GPP technologies.

PGW 160 is responsible for IP address allocation for UE 154 as well as quality of service (QoS) enforcement and flow based charging according to rules from policy control and charging rules function (PCRF) 164. PGW 160 is responsible for the filtering of downlink packets into multiple QoS based bearers. PGW 160 also serves as the mobility anchor for inter-working with non-3GPP technologies such as CDMA 2000 and WiMAX. PCRF 164 is responsible for policy control decision making as well as flow based charging functionalities functions residing with PGW 160.

Home subscriber server (HSS) 166 contains the users' subscription data, such as the evolved packet system (EPS)-subscribed QoS profile. HSS 166 holds information about PDNs 160 to which the user can connect. It also holds information such as the identity of MME 156 to which the user is currently attached or registered.

In a wireless mobile network, as the number of subscribers grows, more network equipment generally needs to be deployed for accommodating the forecasted network traffic. For example, in a GSM network, additional BTSs may be planned to be introduced, and the traffic on the existing BTSs also may grow. As a consequence, additional core network equipment, such as BSCs, MSCs, and SGSNs, should be deployed. As another example, in an LTE network, additional eNodeBs may be planned to be introduced, and the traffic on the existing eNodeBs also may grow. As a result, additional core network equipment, such as MMEs, SGWs and PGWs, should be deployed.

The accuracy of the forecast for such growth generally determines the cost, effectiveness and efficiency of the equipment deployment, and of the performance of the modified network.

### SUMMARY OF THE INVENTION

An embodiment method of forecasting traffic growth for a mobile wireless network in a network planning period includes determining traffic growth of a plurality of service types, and defining a plurality of clusters each containing a respective quantity of cell sites that share similar traffic growth characteristics. The method further includes determining seasonality factors in traffic growth for the plurality of service types in each of the plurality of clusters, and identifying and rejecting outliers in historical traffic measurements. The method also includes utilizing cyclo-stationary weekly traffic behavior to increase a quantity of sample points to accelerate traffic growth estimator convergence

An embodiment computer system for forecasting traffic growth for a mobile wireless network in a network planning period includes a processor and a computer readable storage medium storing programming for execution by the processor. The programming includes instructions to determine traffic growth of a plurality of service types, and define a plurality of clusters each containing a respective quantity of cell sites that share similar traffic growth characteristics. The programming further includes instructions to determine seasonality factors in traffic growth for the plurality of service types in each of the plurality of clusters, to identify and reject outliers in historical traffic measurements, and to utilize cyclo-stationary weekly traffic behavior to increase a quantity of sample points to accelerate traffic growth estimator convergence.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1A is a block diagram of a GSM wireless communications network;

FIG. 1B is a block diagram of an LTE wireless communications network;

FIG. 2 is a map of site clusters and cluster traffic growth forecasts;

FIG. 3 is a cluster traffic growth forecast graph;

FIG. 4 is flow diagram for forecasting mobile network traffic growth by cluster;

FIG. 5 is a flow diagram for the modified Holt-Winters algorithm;

FIGS. 6A and 6B are flow diagrams for the Kalman algorithm with seasonality;

FIG. 7 is a flow diagram for the cluster algorithm;

FIG. 8 is a graph of cluster growth versus market growth; and

FIG. 9 illustrates a computing platform that may be used for implementing, for example, the devices and methods described herein, in accordance with an embodiment.

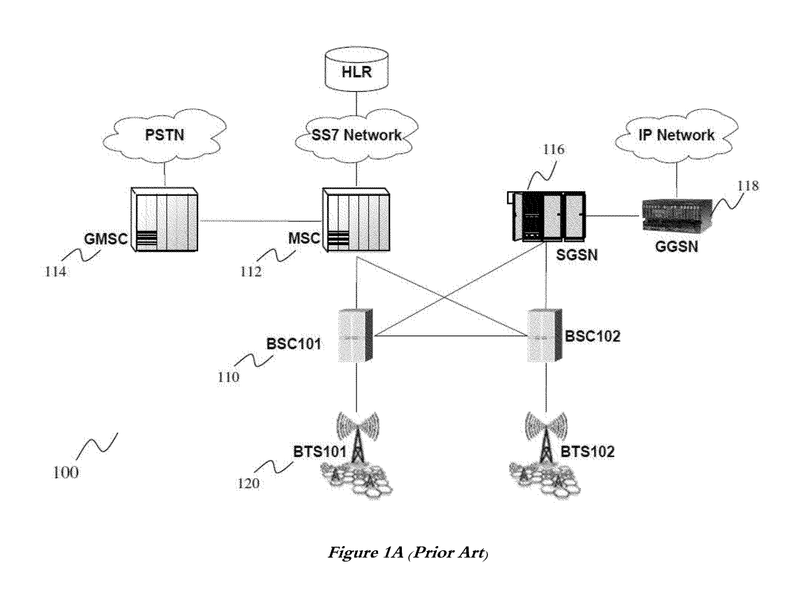

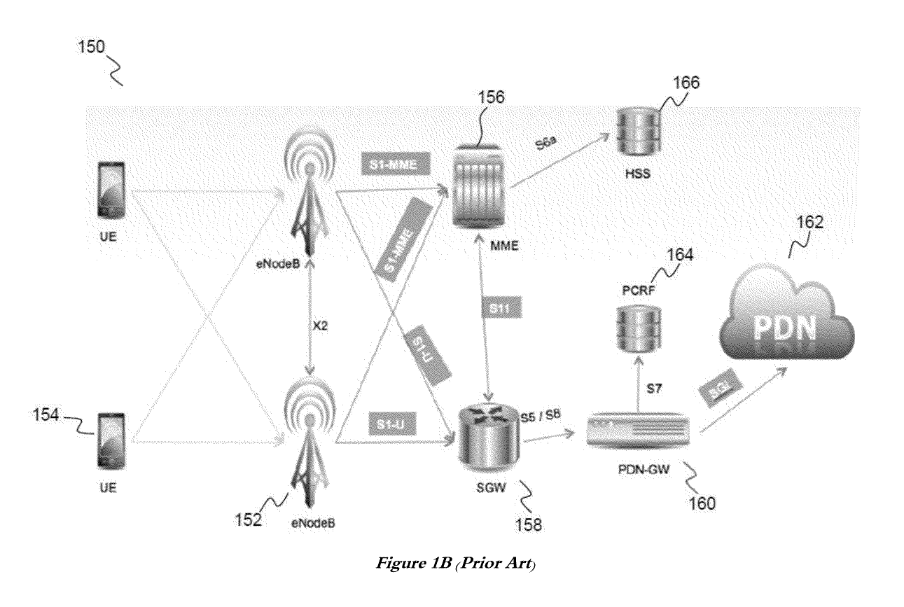

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention is described with respect to embodiments in a specific context, namely a wireless mobile broadband network. The invention may be applied to any type of cellular network technology, such as GSM/GPRS cdmaOne, CDMA2000, EV-DO, EDGE, UMTS, DECT, Digital AMPS, LTE, iDEN, and the like.

Traffic patterns for mobile networks are rapidly evolving. Hyper-competition among mobile broadband service providers is causing wireless subscriber average revenue per user (ARPU) to erode. Mobile broadband service providers spend billions of dollars on network infrastructure, and need to reduce the cost of network equipment to stay competitive. Current forecasting techniques for network infrastructure planning and equipment deployment, however, contain significant latency. Further, inaccuracy in forecasting can lead to stranded capital, increased operational expense and poor end-user experience.

Current approaches to mobile traffic forecasting generally use historical busy hour traffic, apply monthly rank statistics to estimate demand, and trend month over month growth rates for an overall market. A disadvantage of the current market forecasting approach is that it includes limited sample points. Also, by using a month of data for a data point, it produces increased latency in convergence for the month-to-month forecast. The forecast estimate is susceptible to forecasting error due to outliers in the data. That is, it does not intelligently identify outliers leveraging growth trends and causing an inaccurate bias on the forecast estimate. Current approaches for forecasting also typically do not account for seasonality.

An embodiment provides a localized mobile broadband traffic forecast. An embodiment provides intelligent localized service forecasting to enable efficient deployment of wireless network equipment. An embodiment method and system provide faster converging and intelligent forecasting for mobile broadband networks.

An embodiment provides intelligent robust estimators with fast convergence to yield an accurate forecast that produces higher returns on capital investments. An embodiment provides an accurate traffic trend forecast for different traffic parameters in small areas (clusters of sites) based on historical traffic measurements. An embodiment groups sites having similar growth characteristics, in terms of growth rates of all traffic parameters and seasonality factors, in the same cluster.

Embodiment localized traffic forecast systems and methods estimate when, where and what types of traffic there will be in the future, to enable just-in-time network deployment. An embodiment provides this just-in-time network deployment with high accuracy; that is, deploying the right equipment in the right place at the right time. This allows mobile broadband service providers to implement just-in-time deployment strategies, which minimize network cost while maintaining high customer satisfactions.

An embodiment traffic growth forecast system and method include a modified Holt-Winters algorithm and/or Kalman filter algorithm with seasonality considerations, to provide seasonal growth rates for different types of traffic in a mobile broadband network. An embodiment robust forecast estimator is used to provide an intelligent traffic prediction that rejects outliers in the data. An embodiment provides rapid adaptation by utilizing daily, weekly or monthly cyclo-stationary traffic behavior to increase sample points, which accelerates estimator convergence on a forecast.

An embodiment cluster-based forecast is localized, distinguishing between different growth rates in different regions for different service types. An embodiment identifies natural regions or clusters of cell sites that experience similar growth rates within a given cluster. An embodiment may conserve an overall market forecast while adapting to localized growth rates. An embodiment utilizes model multiple temporal cyclo-stationary patterns for weekly, monthly, and/or seasonal growth rates.

In an embodiment, traffic forecast algorithms compute the traffic trends and growth rates for different traffic parameters, such as voice Erlangs, R99 UL data, R99 DL data, HSUPA, HSDPA and LTE uplink and downlink traffic. An embodiment forecasts a trend in accordance with historical measurements of different traffic parameters made in the past.

An embodiment considers seasonality factors, which, as used herein, may include weekly time periods, monthly time periods, as well as non-monthly time periods in a year (e.g., weather seasons, school year, etc.). Generally, seasonality differentiates or measures how mobile traffic varies over time, such as during the time of day (e.g., during commuting, the start of the business day, lunch hour, the afternoon, evening, nighttime), during the day of the week (e.g., weekday versus weekend or holiday), during different months or seasons in the year (e.g., standard work weeks versus typical vacation/holiday periods, or school year versus the summer). Further, the seasonality may include a spatial factor. For example, traffic forecasts for the winter and the summer may be quite different in a ski area versus a beach area, or for daytime and nighttime in an urban area versus a suburban/rural area, or for weekdays and the weekend in an urban area versus a suburban/rural area or a resort area.

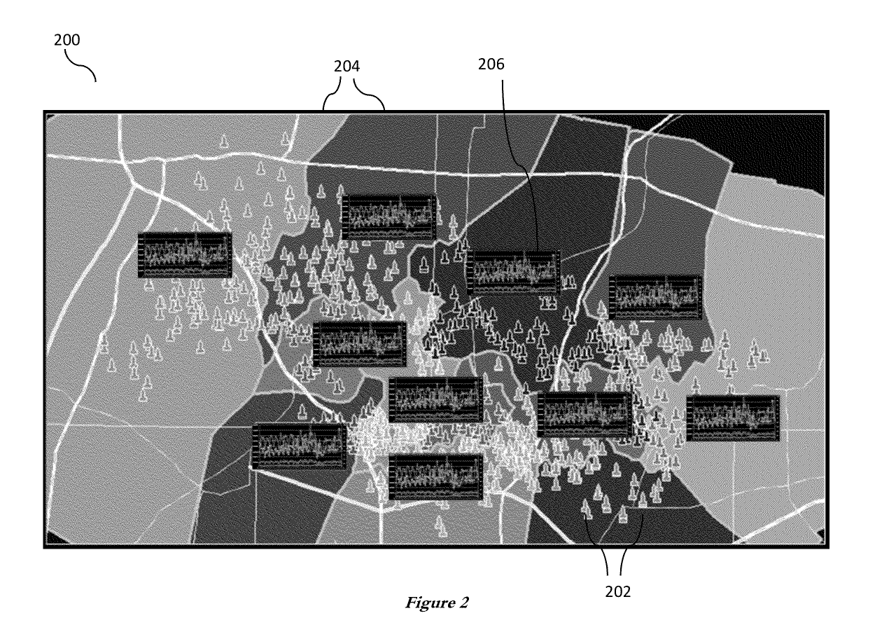

FIG. 2 illustrates an embodiment map 200 of a geographical area in which a wireless mobile broadband network is deployed. The mobile network includes many cell sites 202 deployed throughout the network. An embodiment clusters the sites 202 into clusters 204, of which there are ten shown (with different shading) in FIG. 2. The sites 202 within any particular cluster 204 have similar growth characteristics to each other. FIG. 2 also illustrates ten embodiment forecasts 206 for each cluster. Forecasts 206 each indicate different traffic growth forecasts for the different cluster geographical areas determined in accordance with historical traffic measurements made in the past.

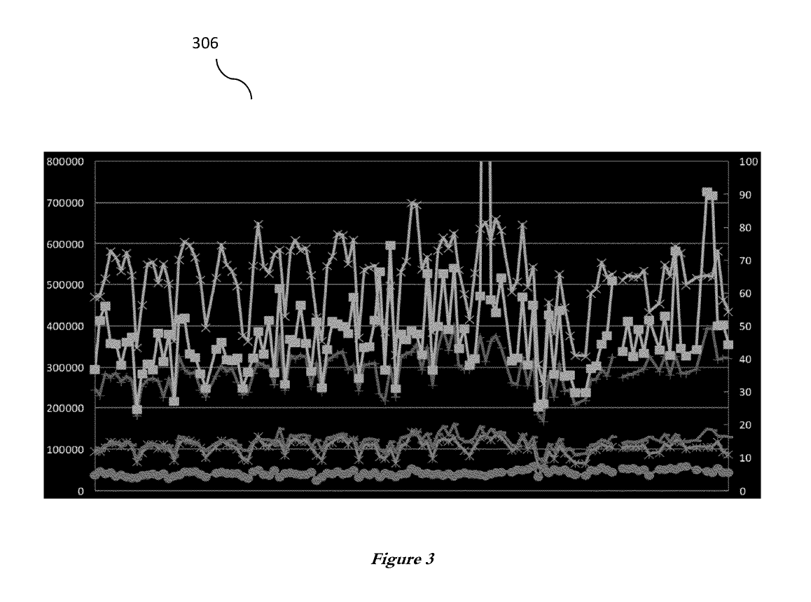

FIG. 3 illustrates an expanded view of a cluster traffic growth forecast graph 306. The various curves in the graph represent, for example, growth rates for voice and data traffic types for 3G and 4G uplink and downlink communications over time. Each curve generally has an overall growth rate, as well as a cyclical variation over time. The time scale may be, for example, daily to show weekly patterns in the growth data, weekly to show monthly patterns in the growth data, or monthly to show seasonal patterns in the data.

Various embodiments include one or both of two forecast algorithms. The first is a modified Holt-Winters algorithm that performs exponential smoothing with adaptive smooth parameters. The second is a Kalman filter algorithm incorporating consideration of seasonality. The algorithms may be used at the sector-carrier level, the site level and the site-cluster (groups) level. Various embodiments also implement a cluster algorithm to group cell sites with similar growth characteristics into individual geographically contiguous clusters.

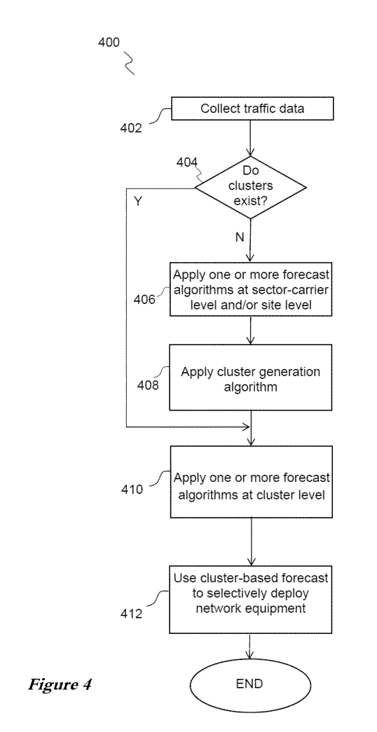

FIG. 4 illustrates an embodiment procedure 400 for forecasting mobile network traffic growth by cluster. In step 402, historical traffic data for cell sites is collected. If clusters do not yet exist, as determined in step 404, one or both of the forecast algorithms is run in step 406 on each cell site to determine a growth rate for each site. Then in step 408 the cluster generation algorithm is used on the site growth data to group the sites into clusters, with each cluster containing of sites having a similar growth rate. Once clusters are determined, one or both of the forecast algorithms are run at the cluster level in step 410 to generate individual forecasts for each cluster. Lastly, in step 412, the cluster-based forecasts are used to selectively deploy or redeploy network equipment, generally to those clusters showing the highest growth rates.

In alternative embodiments, these algorithms may be used separately from each other. For example, the clusters already may be determined, and thus only one or both of the forecast algorithms are used to generate a forecast for each cluster. In another example, both of the forecast algorithms may be run on historical data for a particular network, geographical region, or within a cluster, and then the forecast estimate is tested against actual data. The algorithm that provides the best forecast is then used for forecasting in that network, region or cluster.

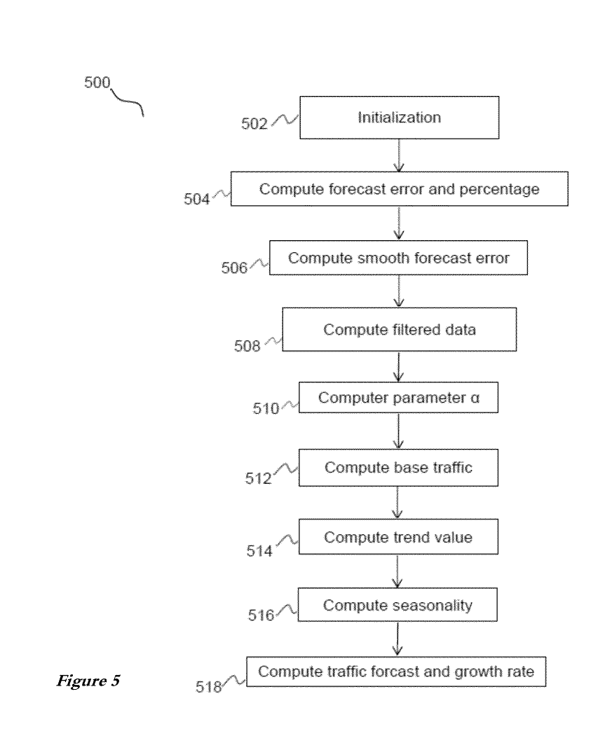

FIG. 5 illustrates the modified Holt-Winters algorithm 500. Step 502 performs initialization, where Dₖ is the historical measured data at k:

B₁=D₁, T₁=D₂−D₁, F₂₁₁=D₂, e₁=0, δ₁=0 and Sₖ=1, for k=2−m, . . . ,0,1

Step 504 computes the forecast error and percentage error (start for k=2):

$${e}_{k} = {D}_{k} - {F}_{k \vert k - 1} and {E}_{k} = \{ \begin{matrix}{e}_{k} / {D}_{k} & if \vert {D}_{k} \vert > 0 \\ 0 & else\end{matrix}$$

Step 506 computes the smoothed forecast error:

δₖ=λ*|Eₖ|+(1−λ)*λₖ₋₁

Step 508 computes the filtered data (κ=2.0)

$${R}_{k} = \{ \begin{matrix}{D}_{k} & if \vert {E}_{k} \vert \leq κ * {δ}_{k} \\ {D}_{k - 1} & else\end{matrix}$$

Step 510 computes parameter α (α_{A}=1.8863 and α_{B}=6.0):

$${α}_{k} = \frac{1}{1 + exp ( {α}_{A} - {α}_{B} * \vert {E}_{k} \vert )}$$

Step 512 computes base traffic:

$${B}_{k} = {α}_{k} * \frac{{R}_{k}}{{S}_{k - m}} + ( 1 - {α}_{k} ) * ( {B}_{k - 1} + {T}_{k - 1} )$$

Step 514 computes the trend value (β=0.1):

$${T}_{k} = \{ \begin{matrix}β * max \{ {B}_{k} - {B}_{k - 1} , - {B}_{k} ) + ( 1 - β ) * {T}_{k - 1} & if \vert {E}_{k} \vert \leq \overline{E} \\ 0 & else\end{matrix}$$

Step 516 computes seasonality (y=0.6)

$${S}_{k} = γ * \frac{{R}_{k}}{{B}_{k}} + ( 1 - γ ) * {S}_{k - m}$$

Lastly, step 518 computes the traffic forecast F_{k+1/k} and growth rate Gₖ:

$${F}_{k + 1 \vert k} = ( {B}_{k} + {T}_{k} ) * {S}_{k + 1 - m} and {G}_{k} = \{ \begin{matrix}{T}_{k} \text{/} {B}_{k} & if \vert {B}_{k} \vert > 0 \\ 0 & else\end{matrix}$$

The parameters and variables used in the modified Holt-Winter algorithm are as follows:

Dₖ—historical measured traffic data at time k;

m—seasonality period (e.g., 7 for weekly cycle of daily data, 12 for yearly cycle of monthly data);

Bₖ—base traffic at time k;

F_{k|k-1}—forecasted traffic of time k at time k−1;

Tₖ estimated growth value at time k;

eₖ—forecasted error at time k;

Eₖ—forecasted error in percentage at time k;

δₖ—smoothed forecasted error at time k;

Rₖ—replacement of Dₖ if Bₖ is an outlier at time k;

αₖ—balance parameter for base traffic at time k;

α_{A} and α_{B}—parameters used for computing

β—balance parameter for growth value;

γ—balance parameter for seasonality;

Sₖ—seasonality ratio at time k;

Gₖ—forecasted growth rate at time k.

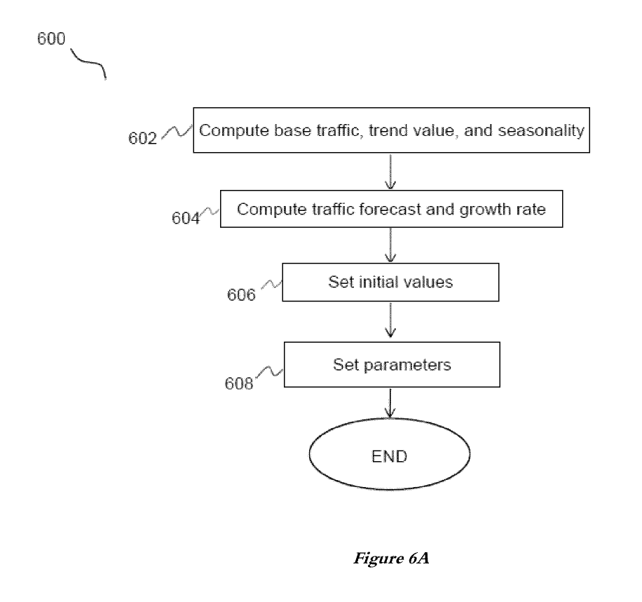

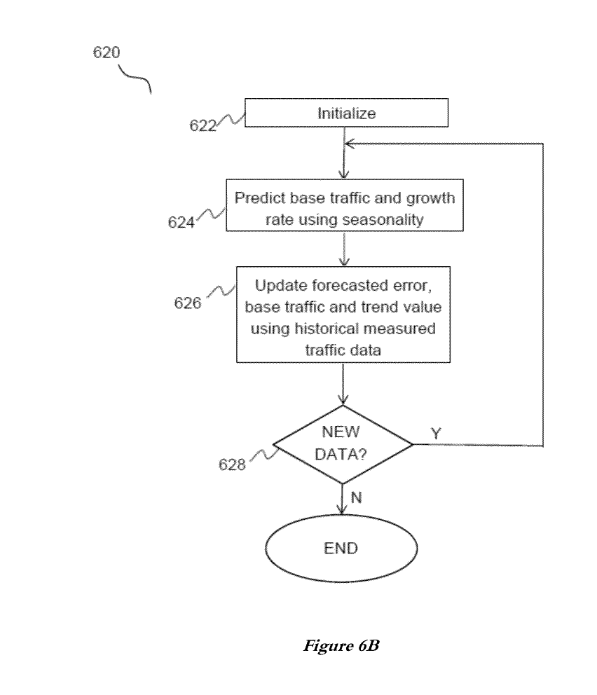

FIG. 6A illustrates Kalman Filter initialization 600. Step 602 computes base traffic Bₖ, trend value Tₖ and seasonality Sₖ:

$$( \begin{matrix}{B}_{k} \\ {T}_{k}\end{matrix} ) = {\hat{x}}_{k \vert k}$$

and Sₖ Step 604 computes the traffic forecast and growth rate:

$${F}_{k + 1 \vert k} = ( {B}_{k} + {T}_{k} ) * {S}_{k + 1 - m} and {G}_{k} = \{ \begin{matrix}{T}_{k} \text{/} {B}_{k} & if \vert {B}_{k} \vert > 0 \\ 0 & else\end{matrix}$$

Step 606 sets initial values (L=1000):

$${B}_{1} = {D}_{1} , {T}_{1} = {D}_{2} - {D}_{1} , {S}_{k} = 1 , for k = 2 - m , … , 0 , 1 and {P}_{0} = [ \begin{matrix}L & 0 \\ 0 & L\end{matrix} ]$$

Finally, step 608 sets other parameters (qₖ=0.00001):

$${F}_{k} = [ \begin{matrix}1 & 1 \\ 0 & 1\end{matrix} ] , {H}_{k} = [ 1 \; 0 ] , {Q}_{k} = [ \begin{matrix}{q}_{t} \text{/} 4 & {q}_{t} \text{/} 2 \\ {q}_{t} \text{/} 2 & {q}_{t}\end{matrix} ] , and {r}_{k} = 0.1$$

FIG. 6B illustrates the Kalman Filter with seasonality consideration 620. Step 622 performs the initialization shown in FIG. 6A. Step 624 predicts base traffic and growth rate using seasonality:

$$\{ \begin{matrix}{\hat{x}}_{k \vert k - 1} = {S}_{k - m} {F}_{k} {\hat{x}}_{k - 1 \vert k - 1} \\ {P}_{k \vert k - 1} = {F}_{k} {P}_{k - 1 \vert k - 1} {F}_{k}^{T} + {Q}_{k}\end{matrix}$$

Step 626 updates the forecasted error, base traffic and trend value using historical measured traffic data:

$$\{ \begin{matrix}{\tilde{e}}_{k} = {D}_{k} - {H}_{k} {\hat{x}}_{k \vert k - 1} \\ {K}_{k} = {P}_{k \vert k - 1} {{H}_{k}^{T} ( {H}_{k} {P}_{k \vert k - 1} {H}_{k}^{T} + {r}_{k} )}^{- 1} \\ {\hat{x}}_{k \vert k} = {\hat{x}}_{k \vert k - 1} + {K}_{k} {\tilde{e}}_{k} \\ {P}_{k \vert k} = ( I - {K}_{k} {H}_{k} ) {P}_{k \vert k - 1}\end{matrix} \\ where seasonality {S}_{k} = [ \begin{matrix}{s}_{k} & 0 \\ 0 & 1\end{matrix} ] , and \\ where {s}_{k} = \{ \begin{matrix}{D}_{k} \text{/} {B}_{k} & if \vert {D}_{k} \vert < 100 * \vert {B}_{k} \vert \\ {D}_{k - m} \text{/} {B}_{k} & otherwise\end{matrix}$$

Step 628 checks to see if there is any new data. If so, the prediction and update steps are executed again. If not, the algorithm ends.

The parameters and variables used in the Kalman filter algorithms are as follows:

Dₖ—historical measured traffic data at time k;

m—seasonality period (e.g., 7 for weekly cycle of daily data, 12 for yearly cycle of monthly data);

Bₖ—base traffic at time k;

Tₖ—estimated growth value at time k;

Sₖ—2×2 seasonality matrix at time k;

sₖ—seasonality ratio at time k;

F_{k|k-1}—forecasted traffic of time k at time k—1;

Gₖ—forecasted growth rate at time k;

\hat{x}_{k|k}—base traffic and growth value vector at time k;

P₀—initial 2×2 P-matrix;

Fₖ—2×2 F-matrix at time k;

Hₖ—1×2 H-matrix at time k;

Qₖ—2×2 Q-matrix at time k;

γₖ—residual at time k;

P_{k|k}—2×2 P-matrix at time k;

\tilde{e}ₖ—forecasted error at time k;

$$I = [ \begin{matrix}1 & 0 \\ 0 & 1\end{matrix} ] - 2 \times 2$$

identity matrix;

\hat{x}_{k|k-1}—a temporary variable (2×1 matrix) at time k;

P_{k|k-1}—a temporary variable (2×2 matrix) at time k;

Kₖ—a temporary variable (2×1 matrix) at time k.

In an embodiment clustering algorithm, sites in a cluster have similar growth rates for all traffic parameters. Further, the sites in a cluster form a contiguous area. The deviation of growth rates of all traffic parameters for a site in the cluster generally is small (e.g., less than a pre-defined value) so that the forecast predictions are applicable to all of the sites in a given cluster. Also, the total site count in a cluster does not exceed a pre-defined value. Sites in a cluster also have a similar seasonality.

The cluster algorithm creates site clusters by grouping sites. Starting from individual sites, the neighbor sites are grouped into clusters by comparing the growth rates and seasonality.

Parameters for the clustering algorithm are determined as follows:
Compute group (cluster) growth rate for traffic parameter p:

$$G ( c , p ) = \frac{{\sum }_{\begin{matrix}all sites \\ in group c\end{matrix}} [ G ( site , p ) \times B ( site , p ) ]}{{\sum }_{\begin{matrix}all sites \\ in group c\end{matrix}} B ( site , p )}$$

Compute growth rate difference between two neighboring groups:

$$d ( {c}_{A} , {c}_{B} ) = \sqrt{{\sum }_{\begin{matrix}for all traffic \\ parameters p\end{matrix}} {[ G ( {c}_{A} , p ) - G ( {c}_{B} , p ) ]}^{2}}$$

Compute growth rate deviation of a group (cluster):

$$σ ( c ) = \sqrt{\frac{1}{P \times siteCount ( c )} {\sum }_{\begin{matrix}all sites \\ in group c\end{matrix}} {\sum }_{\begin{matrix}for all traffic \\ parameters p\end{matrix}} {[ G ( site , p ) - G ( site , p ) ]}^{2}}$$

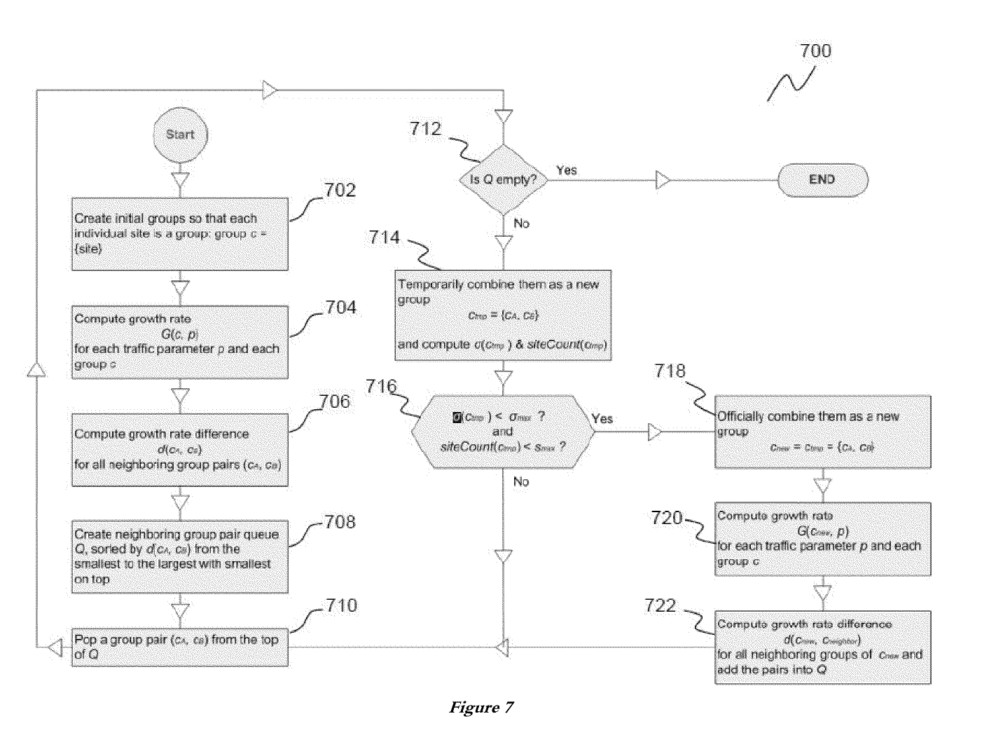

FIG. 7 illustrates clustering algorithm 700. Step 702 creates initial groups so that each individual site is a group. Step 704 computes the growth rate for each traffic parameter and each group. Step 706 computes the growth rate difference for all neighboring group pairs. Step 708 creates a neighboring group pair queue, sorted by the growth rate difference, from the smallest on top to the largest on the bottom of the queue. Step 710 pops a group pair from the top of the queue. Step 712 determines whether the queue is empty, and, if it is, the algorithm ends.

If the queue is not empty, step 714 temporarily combines the pair as a new group and computes the growth rate deviation and site count. Step 716 then determines whether the growth rate deviation and site count are both less than their maximum allowed values. If one of them is not, the algorithm returns to step 710 for further processing of the next pair in the queue. If both the growth rate deviation and site count are less than their maximum allowed values, then step 718 combines the pair as a new group. Step 720 computes the growth rate for each traffic parameter and each group. Step 722 computes the growth rate difference for all neighboring groups of the new group and adds the pairs to the queue. The algorithm returns to step 710 for further processing of the next pair in the queue.

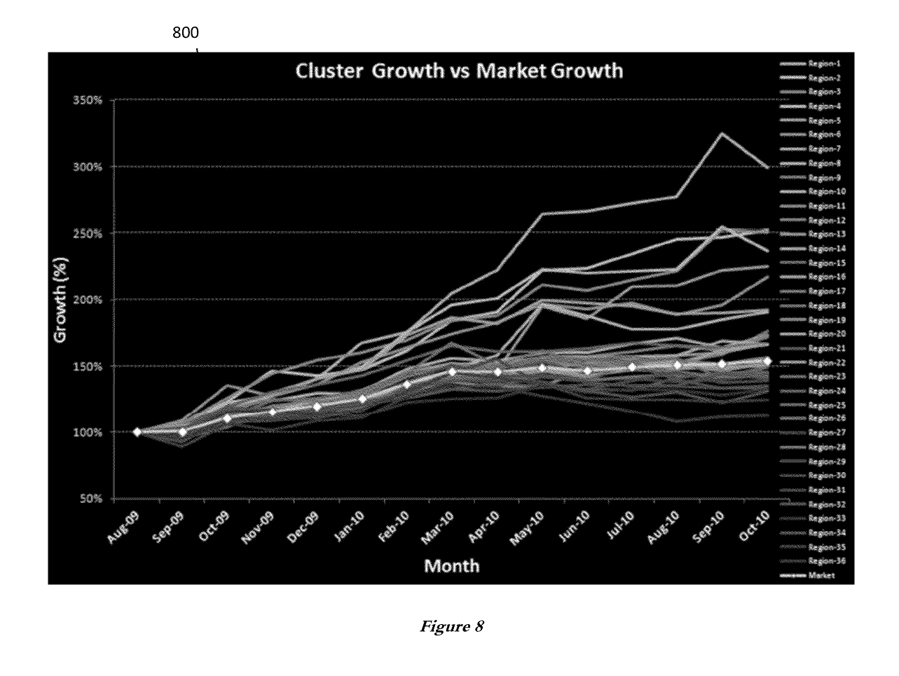

FIG. 8 is a graph 800 illustrating cluster growth versus market growth. The market growth is represented as the curve containing the diamond points. The market growth shows the overall growth of the market based on monthly traffic data values for a network. The market growth information does not show variations that may be occurring in a network in different regions and at different times. In contrast, the individual cluster growth curves, starting with the region 1 curve at the top and working down to the region 36 curve at the bottom, show that there are significant differences in the growth rates of the different clusters. Based on this information, a service provider can deploy wireless equipment to those regions that have the highest traffic growth rate, such as region 1, or such as regions 1-8, for example. Other regions that have a much lower growth rate, such as the higher numbered regions like region 36, may not be growing sufficiently to warrant equipment deployment.

In many cases, only a small sample of historical monthly busy hour measurements is available due to lack of long historical records, such as for a new deployment, or a newly modified deployment. In such as case, a market forecast providing a monthly traffic forecast is inaccurate because of the small sample size. In contrast, in an embodiment using daily busy hour measurement sample data, the samples are much larger compared to monthly samples, and thus provide a more accurate forecast. An embodiment determines the monthly traffic forecast using the daily data. That is, daily traffic growth rates are determined using daily data samples. Then the daily growth rates are converted to weekly or monthly growth rates.

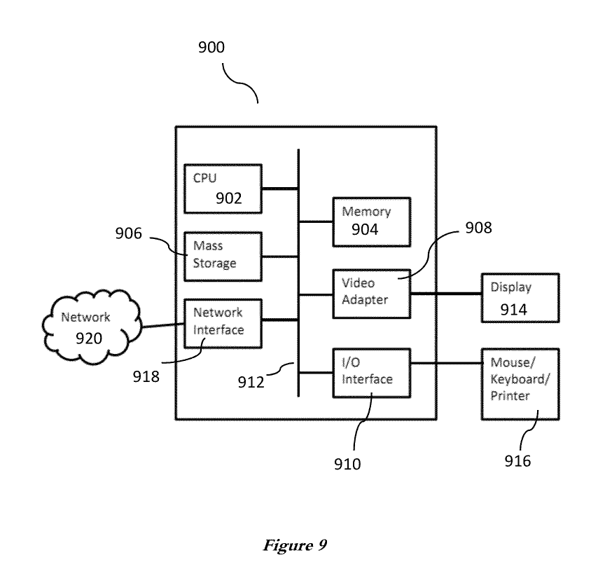

FIG. 9 is a block diagram of a processing system 900 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU) 902, memory 904, a mass storage device 906, a video adapter 908, and an I/O interface 910 connected to a bus 912.

The bus may be one or more of any type of several bus architectures including a memory bus or memory controller, a peripheral bus, video bus, or the like. The CPU may comprise any type of ctronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display 914 coupled to the video adapter and the mouse/keyboard/printer 916 coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces 918, which may comprise wired links, such as an Ethernet cable or the like, and/or wireless links to access nodes or different networks. The network interface allows the processing unit to communicate with remote units via the networks 920. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

Embodiments disclosed herein may be implemented and used in conjunction with embodiments disclosed in U.S. patent application Ser. No. 10/585,011, filed Jun. 29, 2006, entitled “System and Method for Analyzing Strategic Network Investments in Wireless Networks;” U.S. patent application Ser. No. 12/443,956, filed Apr. 1, 2009, entitled “System and Method for Re-home Sequencing Optimization,” and U.S. Pat. No. 8,073,720, issued Dec. 6, 2011, entitled “System and Method for Reduction of Cost of Ownership for Wireless Communication Networks,” which applications/patents are hereby incorporated herein by reference.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of forecasting traffic growth for a mobile wireless network in a network planning period, the method comprising:
determining, using a computer system, traffic growth of a plurality of service types
defining, using the computer system, a plurality of clusters each containing a respective quantity of cell sites that share similar traffic growth characteristics;
determining, using the computer system, seasonality factors in traffic growth for the plurality of service types in each of the plurality of clusters;
identifying and rejecting, using the computer system, outliers in historical traffic measurements; and
utilizing, using the computer system, cyclo-stationary weekly traffic behavior to increase a quantity of sample points to accelerate traffic growth estimator convergence.

2. The method of claim 1, further comprising using a Kalman filter algorithm with seasonality as a robust estimator to forecast traffic growth for the plurality of service types with seasonality factors for each of the clusters in accordance with the historical traffic measurements.

3. The method of claim 2, further comprising utilizing dynamics of the mobile wireless network to reject non-realizable traffic behaviors that reflect errors in the historical measurements.

4. The method of claim 2, wherein the seasonality is a cycle-stationary pattern selected from the group consisting of hourly, daily, weekly and yearly.

5. The method of claim 1, further comprising using a modified Holt-Winters algorithm with seasonality as a robust estimator to forecast traffic growth for the plurality of service types with seasonality factors for each of the clusters in accordance with the historical traffic measurements.

6. The method of claim 1, further comprising:
using a site cluster algorithm to group neighboring cell sites with similar traffic growth characteristics into a respective one of the plurality of clusters; and
using a Kalman filter algorithm with seasonality for cluster level traffic growth forecasts.

7. The method of claim 1, further comprising:
using a site cluster algorithm to group neighboring cell sites with similar traffic growth characteristics into a respective one of the plurality of clusters; and
using a modified Holt-Winters algorithm with seasonality for cluster level traffic growth forecasts.

8. The method of claim 1, further comprising identifying multiple temporary cyclo-stationary traffic patterns to generate traffic growth rates in reduced sampling periods by filtering out seasonality factors.

9. The method of claim 8, wherein filtering out the seasonality factors generates additional sample points to provide an accurate traffic forecast in a short time period.

10. The method of claim 1, wherein the plurality of service types are selected from the group consisting of voice, R99 uplink, R99 downlink, HSUPA, HSDPA, LTE uplink and downlink traffic, and combinations thereof.

11. An computer system for forecasting traffic growth for a mobile wireless network in a network planning period, the computer system comprising:
a processor; and
a computer readable storage medium storing programming for execution by the processor, the programming including instructions to:
determine traffic growth of a plurality of service types
define a plurality of clusters each containing a respective quantity of cell sites that share similar traffic growth characteristics;
determine seasonality factors in traffic growth for the plurality of service types in each of the plurality of clusters;
identify and reject outliers in historical traffic measurements; and
utilize cyclo-stationary weekly traffic behavior to increase a quantity of sample points to accelerate traffic growth estimator convergence.

12. The computer system of claim 11, wherein the programming further comprises instructions to use a Kalman filter algorithm with seasonality as a robust estimator to forecast traffic growth for the plurality of service types with seasonality factors for each of the clusters in accordance with the historical traffic measurements.

13. The computer system of claim 12, wherein the programming further comprises instructions to utilize dynamics of the mobile wireless network to reject non-realizable traffic behaviors that reflect errors in the historical measurements.

14. The computer system of claim 12, wherein the seasonality is a cycle-stationary pattern selected from the group consisting of hourly, daily, weekly and yearly.

15. The computer system of claim 11, wherein the programming further comprises instructions to use a modified Holt-Winters algorithm with seasonality as a robust estimator to forecast traffic growth for the plurality of service types with seasonality factors for each of the clusters in accordance with the historical traffic measurements.

16. The computer system of claim 11, wherein the programming further comprises instructions to:
use a site cluster algorithm to group neighboring cell sites with similar traffic growth characteristics into a respective one of the plurality of clusters; and
use a Kalman filter algorithm with seasonality for cluster level traffic growth forecasts.

17. The computer system of claim 11, wherein the programming further comprises instructions to:
use a site cluster algorithm to group neighboring cell sites with similar traffic growth characteristics into a respective one of the plurality of clusters; and
use a modified Holt-Winters algorithm with seasonality for cluster level traffic growth forecasts.

18. The computer system of claim 11, wherein the programming further comprises instructions to identify multiple temporary cyclo-stationary traffic patterns to generate traffic growth rates in reduced sampling periods by filtering out seasonality factors.

19. The computer system of claim 18, wherein the filtering out the seasonality factors generates additional sample points to provide an accurate traffic forecast in a short time period.

20. The computer system of claim 11, wherein the plurality of service types are selected from the group consisting of voice, R99 uplink, R99 downlink, HSUPA, HSDPA, LTE uplink and downlink traffic, and combinations thereof.
